(19) United States
(12) Patent Application Publication
(10) Pub. No.: US 2025/0093968 A1
(43) Pub. Date: Mar. 20, 2025

(54) Handheld Controllers with Surface Marking Capabilities

(71) Applicant: Apple Inc., Cupertino, CA (US)

(72) Inventors: Ian P Colahan, San Jose, CA (US); Christopher K Ewy, San Francisco, CA (US); Yuhao Pan, Sunnyvale, CA (US); Tong Chen, Fremont, CA (US); David D Dashevsky, San Jose, CA (US)

(21) Appl. No.: 18/812,916

(22) Filed: Aug. 22, 2024

Related U.S. Application Data
(60) Provisional application No. 63/584,022, filed on Sep. 20, 2023.

(51) Int. Cl. G06F 3/03; G06F 3/0354; G06F 3/038

(52) U.S. Cl. CPC G06F 3/0317; G06F 3/03545; G06F 3/0383

(57) ABSTRACT

A system may include an electronic device such as a head-mounted device and a handheld controller for controlling the electronic device. The handheld controller may have a housing with an elongated shaft extending between first and second tip portions. A removable tip member may be coupled to the first tip portion. A position sensor may be located in the removable tip member and may be used to track surface markings made with the handheld controller on a surface. The position sensor may be an optical flow sensor, a visual inertial odometry camera, an interferometer, or other sensor. A force sensor at the first tip portion may be used to detect when the tip contacts a surface. The position sensor may switch from air input mode to surface marking mode in response to detecting contact with the surface.

This application claims the benefit of U.S. provisional patent application No. 63/584,022, filed Sep. 20, 2023, which is hereby incorporated by reference herein in its entirety.

### FIELD

This relates generally to computer systems and, more particularly, to input devices for computer systems.

### BACKGROUND

Electronic devices such as computers can be controlled using computer mice and other input accessories. In virtual reality systems, force-feedback gloves can be used to control virtual objects. Cellular telephones may have touch screen displays and vibrators that are used to create haptic feedback in response to touch input.

Devices such as these may not be convenient for a user, may be cumbersome or uncomfortable, or may provide inadequate feedback.

### SUMMARY

A system may include an electronic device such as a head-mounted device and a handheld controller for controlling the electronic device. The head-mounted device or other device may have a display configured to display virtual content that is overlaid onto real-world content.

The handheld controller may be operable in a surface marking mode and an air input mode. In surface marking mode, the handheld controller can be used to mark on any surface, such as a tabletop surface or a desk surface. In air input mode, the handheld controller may be used to interact with virtual objects and/or may be used for other functions.

The handheld controller may have a housing with an elongated shaft extending between first and second tip portions. A removable tip member may be coupled to the first tip portion. The handheld controller may have a spring-loaded member at the first tip portion that retracts into the housing to form an opening that receives a portion of the removable tip member. In some arrangements, the removable tip member may be held in place using a friction fit having a magnetic release.

A position sensor may be located in the removable tip member and may be used to track surface markings made with the handheld controller on a surface. The position sensor may be an optical flow sensor, a visual inertial odometry camera, an interferometer, or other sensor. A force sensor at the first tip portion may be used to detect when the tip member contacts a surface. The device position sensor may switch from air input mode to surface marking mode in response to detecting contact with the surface.

### BRIEF DESCRIPTION OF THE DRAWINGS

FIG. 1 is a schematic diagram of an illustrative system with a handheld controller in accordance with an embodiment.

FIG. 2 is a perspective view of an illustrative handheld controller in accordance with an embodiment.

FIG. 3 is a side view of an illustrative handheld controller with a removable tip member and one or more sensors for tracking surface markings in accordance with an embodiment.

FIG. 4 is a perspective view of an illustrative handheld controller having a spring-loaded member that retracts into a housing to form an opening for receiving a removable tip member in accordance with an embodiment.

FIG. 5 is a diagram of an illustrative system including a handheld controller having an optical flow sensor that tracks surface markings while a camera tracks tilt and liftoff of the handheld controller relative to the surface in accordance with an embodiment.

FIG. 6 is a side view of an illustrative handheld controller having light-emitting elements distributed around a periphery of an optical flow sensor in accordance with an embodiment.

FIG. 7 is a side view of an illustrative handheld controller having multiple optical flow sensors located at one end of the handheld controller in accordance with an embodiment.

FIG. 8 is a side view of an illustrative handheld controller having cameras distributed at one or more locations on the shaft and/or tip of the handheld controller in accordance with an embodiment.

FIG. 9 is a side view of an illustrative handheld controller having one or more interferometers for tracking surface markings in accordance with an embodiment.

### DETAILED DESCRIPTION

Electronic devices that are configured to be held in the hand of a user may be used to gather user input and to provide a user with output. For example, electronic devices that are configured to control one or more other electronic devices, which are sometimes referred to as controllers, handheld controllers, or handheld input devices, may be used to gather user input and to supply output. A handheld controller may, as an example, include an inertial measurement unit with an accelerometer for gathering information on controller motions such as swiping motions, waving motions, writing movements, drawing movements, shaking motions, rotations, etc., and may include wireless communications circuitry for communicating with external equipment such as a head-mounted device, may include tracking features such as active or passive visual markers that can be tracked with an optical sensor in an external electronic device, may include input devices such as touch sensors, force sensors, buttons, knobs, wheels, etc., may include sensors for gathering information on the interactions between the handheld controller, the user's hands interacting with the controller, and the surrounding environment. The handheld controller may include a haptic output device to provide the user's hands with haptic output and may include other output components such as one or more speakers.

Handheld controllers can be held in one or both of a user's hands. Users can use the handheld controllers to interact with any suitable electronic equipment. For example, a user may use one or more handheld controllers to interact with a virtual reality or mixed reality system (e.g., a head-mounted device with a display), to supply input to a desktop computer, tablet computer, cellular telephone, watch, ear buds, or other accessory, to control household items such as lighting, televisions, thermostats, appliances, etc., or to interact with other electronic equipment.

Handheld controllers may gather user input from a user. The user may use the handheld controllers to control a virtual reality or mixed reality device (e.g., head-mounted equipment such as glasses, goggles, a helmet, or other device with a display). During operation, the handheld controller may gather user input such as information on interactions between the handheld controller(s) and the surrounding environment (e.g., real-world surfaces, objects, etc.), interactions between a user's fingers or hands and the surrounding environment, and interactions associated with virtual content displayed for a user.

Haptic output may be provided to the user's fingers using the handheld controller. Haptic output may be used, for example, to provide the fingers of a user with a desired sensation (e.g., texture, weight, torque, pushing, pulling, etc.) as the user interacts with real or virtual objects using the handheld controller. Haptic output can also be used to create detents, to provide localized or global haptic feedback in response to user input that is supplied to the handheld controller, and/or to provide other haptic effects.

The user input may be used in controlling visual output on a display (e.g., a head-mounted display, a computer display, etc.). For example, the handheld controller may be used in a surface marking mode in which the handheld controller can be used to mark on any surface while a display is used to display the markings made by the handheld controller on the surface. One or more sensors such as a device position sensor and a force sensor may be located at the tip of the handheld controller for tracking surface markings. The force sensor may be used to detect contact between the tip and the surface. In response, the device position sensor may be operated in surface marking mode to track the location of the tip relative to the surface. Additional sensors such as motion sensors and cameras in the handheld controller and/or the head-mounted device may be used to measure the tilt of the handheld controller relative to the surface during surface marking mode so that the location information gathered by the device position sensor can be transposed to account for tilt. The device position sensor may be an optical flow sensor, a visual inertial odometry camera, an interferometer, and/or other position sensor.

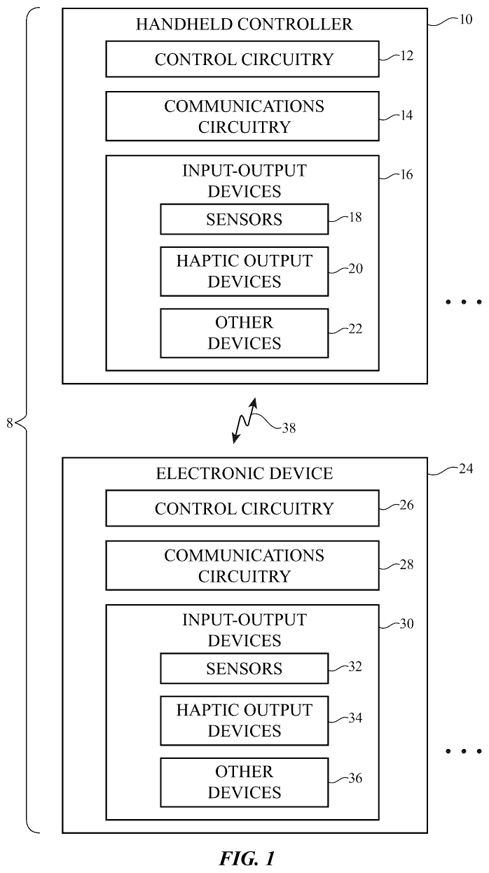

FIG. 1 is a schematic diagram of an illustrative system of the type that may include one or more handheld controllers. As shown in FIG. 1, system 8 may include electronic device(s) such as handheld controller(s) 10 and other electronic device(s) 24. Each handheld controller 10 may be held in the hand of a user. Additional electronic devices in system 8 such as devices 24 may include devices such as a laptop computer, a computer monitor containing an embedded computer, a tablet computer, a desktop computer (e.g., a display on a stand with an integrated computer processor and other computer circuitry), a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a remote control, a navigation device, an embedded system such as a system in which equipment is mounted in a kiosk, in an automobile, airplane, or other vehicle, a removable external case for electronic equipment, a strap, a wrist band or head band, a removable cover for a device, a case or bag that has straps or that has other structures to receive and carry electronic equipment and other items, a necklace or arm band, a wallet, sleeve, pocket, or other structure into which electronic equipment or other items may be inserted, part of a chair, sofa, or other seating (e.g., cushions or other seating structures), part of an item of clothing or other wearable item (e.g., a hat, belt, wrist band, headband, sock, glove, shirt, pants, etc.), or equipment that implements the functionality of two or more of these devices.

With one illustrative configuration, which may sometimes be described herein as an example, device 10 is a handheld controller having an elongated marker-shaped housing configured to be grasped within a user's fingers or a housing with other shapes configured to rest in a user's hand, and device(s) 24 is a head-mounted device, cellular telephone, tablet computer, laptop computer, wristwatch device, a device with a speaker, or other electronic device (e.g., a device with a display, audio components, and/or other output components). A handheld controller with a marker-shaped housing may have an elongated housing that spans across the width of a user's hand and that can be held like a pen, pencil, marker, wand, or tool.

Devices 10 and 24 may include control circuitry 12 and 26. Control circuitry 12 and 26 may include storage and processing circuitry for supporting the operation of system 8. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 12 and 26 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc.

To support communications between devices 10 and 24 and/or to support communications between equipment in system 8 and external electronic equipment, control circuitry 12 may communicate using communications circuitry 14 and/or control circuitry 26 may communicate using communications circuitry 28. Circuitry 14 and/or 28 may include antennas, radio-frequency transceiver circuitry, and other wireless communications circuitry and/or wired communications circuitry. Circuitry 14 and/or 28, which may sometimes be referred to as control circuitry and/or control and communications circuitry, may, for example, support bidirectional wireless communications between devices 10 and 24 over wireless link 38 (e.g., a wireless local area network link, a near-field communications link, or other suitable wired or wireless communications link (e.g., a Bluetooth® link, a WiFi® link, a 60 GHz link or other millimeter wave link, etc.). Devices 10 and 24 may also include power circuits for transmitting and/or receiving wired and/or wireless power and may include batteries. In configurations in which wireless power transfer is supported between devices 10 and 24, in-band wireless communications may be supported using inductive power transfer coils (as an example).

Devices 10 and 24 may include input-output devices such as devices 16 and 30. Input-output devices 16 and/or 30 may be used in gathering user input, in gathering information on the environment surrounding the user, and/or in providing a user with output. Devices 16 may include sensors 18 and devices 30 may include sensors 32. Sensors 18 and/or 32 may include force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors (e.g., ultrasonic sensors for tracking device orientation and location and/or for detecting user input such as finger input), and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or inertial measurement units that contain some or all of these sensors), muscle activity sensors (EMG) for detecting finger actions, radio-frequency sensors, depth sensors (e.g., structured light sensors and/or depth sensors based on stereo imaging devices), optical sensors such as self-mixing interferometric sensors and light detection and ranging (lidar) sensors that gather time-of-flight measurements, optical sensors such as visual odometry and/or visual inertial odometry sensors that gather position and/or orientation information using images gathered with digital image sensors in cameras, gaze tracking sensors, visible light and/or infrared cameras having digital image sensors, humidity sensors, moisture sensors, and/or other sensors. In some arrangements, devices 10 and/or 24 may use sensors 18 and/or 32 and/or other input-output devices 16 and/or 30 to gather user input (e.g., buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.). If desired, device 10 and/or device 24 may include rotating buttons (e.g., a crown mechanism on a watch or other suitable rotary button that rotates and that optionally can be depressed to select items of interest). Alphanumeric keys and/or other buttons may be included in devices 16 and/or 30. In some configurations, sensors 18 may include joysticks, roller balls, optical sensors (e.g., lasers that emit light and image sensors that track motion by monitoring and analyzing changings in the speckle patterns and other information associated with surfaces illuminated with the emitted light as device 10 is moved relative to those surfaces), fingerprint sensors, and/or other sensing circuitry. Radio-frequency tracking devices may be included in sensors 18 to detect location, orientation, and/or range. Beacons (e.g., radio-frequency beacons) may be used to emit radio-frequency signals at different locations in a user's environment (e.g., at one or more registered locations in a user's home or office). Radio-frequency beacon signals can be analyzed by devices 10 and/or 24 to help determine the location and position of devices 10 and/or 24 relative to the beacons. If desired, devices 10 and/or 24 may include beacons. Frequency strength (received signal strength information), beacon orientation, time-of-flight information, and/or other radio-frequency information may be used in determining orientation and position information. At some frequencies (e.g., lower frequencies such as frequencies below 10 GHz), signal strength information may be used, whereas at other frequencies (e.g., higher frequencies such as frequencies above 10 GHZ), indoor radar schemes may be used). If desired, light-based beacons, ultrasonic beacons, and/or other beacon devices may be used in system 8 in addition to or instead of using radio-frequency beacons and/or radio-frequency radar technology.

Devices 16 and/or 30 may include haptic output devices 20 and/or 34. Haptic output devices 20 and/or 34 can produce motion that is sensed by the user (e.g., through the user's fingertips). Haptic output devices 20 and/or 34 may include actuators such as electromagnetic actuators, motors, piezoelectric actuators, electroactive polymer actuators, vibrators, linear actuators (e.g., linear resonant actuators), rotational actuators, actuators that bend bendable members, actuator devices that create and/or control repulsive and/or attractive forces between devices 10 and/or 24 (e.g., components for creating electrostatic repulsion and/or attraction such as electrodes, components for producing ultrasonic output such as ultrasonic transducers, components for producing magnetic interactions such as electromagnets for producing direct-current and/or alternating-current magnetic fields, permanent magnets, magnetic materials such as iron or ferrite, and/or other circuitry for producing repulsive and/or attractive forces between devices 10 and/or 24). In some situations, actuators for creating forces in device 10 may be used in applying a sensation on a user's fingers (e.g., a sensation of weight, texture, pulling, pushing, torque, etc.) and/or otherwise directly interacting with a user's fingers. In other situations, these components may be used to interact with each other (e.g., by creating a dynamically adjustable electromagnetic repulsion and/or attraction force between a pair of devices 10 and/or between device(s) 10 and device(s) 24 using electromagnets).

If desired, input-output devices 16 and/or 30 may include other devices 22 and/or 36 such as displays (e.g., in device 24 to display images for a user), status indicator lights (e.g., a light-emitting diode in device 10 and/or 24 that serves as a power indicator, and other light-based output devices), speakers and other audio output devices, electromagnets, permanent magnets, structures formed from magnetic material (e.g., iron bars or other ferromagnetic members that are attracted to magnets such as electromagnets and/or permanent magnets), batteries, etc. Devices 10 and/or 24 may also include power transmitting and/or receiving circuits configured to transmit and/or receive wired and/or wireless power signals.

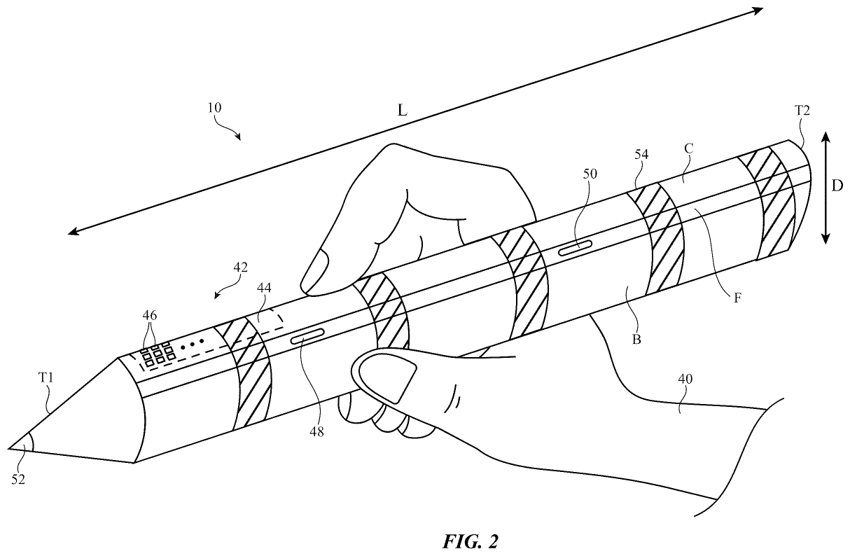

FIG. 2 is a perspective view of a user's hands (hands 40) and an illustrative handheld controller 10. As shown in FIG. 2, controller 10 may be an elongated marker-shaped electronic device that fits within the user's hand 40. The elongated shape of controller 10 allows hand 40 to hold controller 10 as if it were a pen, pencil, marker, or other writing implement. In other configurations, controller 10 may be held in hand 40 as a wand or baton would be held. In general, controller 10 may be held in hand 40 in any suitable manner (e.g., at the end, in the middle, between two, three, four, or all five fingers, with both hands, etc.).

A user may hold one or more of devices 10 simultaneously. For example, a user may hold a single one of devices 10 in the user's left or right hand. As another example, a user may hold a first device 10 in the user's left hand and a second device 10 in the user's right hand. Arrangements in which multiple devices 10 are held in one hand may also be used. Configurations in which devices 10 have housings that are held within a user's hands are sometimes described herein as an example.

Control circuitry 12 (and, if desired, communications circuitry 14 and/or input-output devices 16) may be contained entirely within device 10 (e.g., in housing 54) and/or may include circuitry that is located in an external structure (e.g., in an external electronic device such as device 24, a console, a storage case, etc.).

In general, electrical components such as control circuitry 12, communications circuitry 14, and/or input-output devices 16 (e.g., sensors 18, haptic output devices 20, and/or other devices 22) may be mounted within and/or on the surface(s) of controller housing 54 in any suitable locations.

As shown in FIG. 2, housing 54 may have an elongated marker shape, elongated tube shape, elongated cylindrical shape, and/or any other elongated shape. Housing 54 which may sometimes be referred to as an enclosure, body, or case, may be formed of plastic, glass, ceramics, fiber composites, metal (e.g., stainless steel, aluminum, etc.), fabric, other suitable materials, or a combination of any two or more of these materials. Housing 54 may be formed using a unibody configuration in which some or all of housing 54 is machined or molded as a single structure or may be formed using multiple structures (e.g., an internal frame structure, one or more structures that form exterior housing surfaces, etc.). Housing 54 may form outer housing walls, tip portions, and/or internal support structures for device 10. Housing 54 may have a length L between 140 mm and 150 mm, between 130 mm and 160 mm, between 100 mm and 200 mm, between 120 mm and 160 mm, greater than 180 mm, less than 180 mm, or any other suitable length. The diameter D of housing 54 may be between 12 mm and 14 mm, between 10 mm and 15 mm, between 11 mm and 16 mm, between 15 mm and 20 mm, between 18 mm and 25 mm, greater than 25 mm, less than 25 mm, or any other suitable diameter.

Housing 54 may have one or more curved surfaces and one or more planar surfaces. In the illustrative example of FIG. 2, device 10 has a curved surface C that wraps around a first portion of device 10 and a flat surface F that extends along a second portion of device 10. If desired, flat surface F may be located on a first side of device 10 and curved surface C may be located on a second opposing side of device 10. Curved surface C and flat surface F wrap around device 10 to form an elongated tube shape that surrounds an elongated interior space for housing internal components such as control circuitry 12, communications circuitry 14, and input-output devices 16. Housing 54 may have an elongated shaft portion such as shaft B extending between first and second tip portions such as tip portion T1 at a first end of device 10 and tip portion T2 at a second opposing end of device 10. One or both of housing tip portions T1 and T2 may be removable from the main elongated shaft B between tip portions T1 and T2.

Ultrasonic sensors, optical sensors, inertial measurement units, touch sensors such as capacitive touch sensor electrodes, strain gauges and other force sensors, radio-frequency sensors, and/or other sensors may be used in gathering sensor measurements indicative of the activities of device 10 and/or hand 40 holding device 10.

In some configurations, controller position, movement, and orientation may be monitored using sensors that are mounted in external electronic equipment (e.g., in a computer or other desktop device, in a head-mounted device or other wearable device, and/or in other electronic device 24 that is separate from device 10). For example, optical sensors such as images sensors that are separate from device 10 may be used in monitoring device 10 to determine their position, movement, and/or orientation. If desired, devices 10 may include passive and/or active optical registration features to assist an image sensor in device 24 in tracking the position, orientation, and/or motion of device 10. For example, devices 10 may include light-emitting devices. The light-emitting devices may include light-emitting diodes, lasers (e.g., laser diodes, vertical cavity surface-emitting lasers, etc.), or other light sources and may operate at visible wavelengths, ultraviolet wavelengths, and/or infrared wavelengths. The light-emitting devices may be arranged in an asymmetric pattern on housing 44 and may emit light that is detected by an image sensor, depth sensor, and/or other light-based tracking sensor circuitry in device 24 (e.g., a head-mounted device, desktop computer, stand-alone camera-based monitoring systems, and/or other electrical equipment with an image sensor or other tracking sensor circuitry). By processing the received patterned of emitted light, device 24 can determine the position, orientation, and/or motion of device 10. If desired, the light-emitting devices can be removable and/or customizable (e.g., a user can customize the location and type of light-emitting devices).

Tracking can also be performed that involves extrapolating from a known body part orientation (e.g., a finger orientation) to produce orientation information on other body parts (e.g., wrist and/or arm orientation estimated using inverse kinematics). Visual odometry sensors may, if desired, be included in devices 10. These sensors may include image sensors that gather frames of image data of the surroundings of devices 10 and may be used in measuring position, orientation, and/or motion from the frame of image data. Lidar, ultrasonic sensors oriented in multiple directions, radio-frequency tracking sensors, and/or other controller tracking arrangements may be used, if desired. In some arrangements, user input for controlling system 8 can include both user input to controller 10 and other user input (e.g., user eye gaze input, user voice input, etc.). For example, gaze tracking information such as a user's point-of-gaze measured with a gaze tracker can be fused with controller input to controller 10 when controlling device 10 and/or devices 24 in system 8. A user may, for example, gaze at an object of interest while device 10 uses one or more of sensors 18 (e.g., an accelerometer, force sensor, touch sensor, etc.) to gather information such as tap input (tap input in which a user taps on device 10 with one or more fingers, tap input in which device 10 taps a table top or other external surface or object, and/or any other tap input resulting in measurable forces and/or accelerometer output from device 10), double-tap input, force input, controller gestures (tapping, swiping, twirling, shaking, writing, drawing, painting, sculpting, gaming, and/or other gestures with device 10, gestures on external surfaces with device 10, gestures on external objects with device 10, gestures interacting with virtual objects, gestures with controller 10 in the air, etc.), drag and drop operations associated with objects selected using a lingering gaze or other point-of-gaze input, etc. The controller input from controller 10 to system 8 may include information on finger orientation, position, and/or motion relative to controller 10, may include information on how forcefully a finger is pressing against surfaces of controller 10 (e.g., force information), may include information on how forcefully controller 10 is pressed against an object or external surface (e.g., how forcefully a tip portion such as tip portion T1 presses against an external surface), may include controller pointing input (e.g., the direction in which controller 10 is pointing), which may be gathered using radio-frequency sensors among sensors 18 and/or other sensors in device(s) 10, and/or may include other controller input.

By correlating user input from a first of devices 10 with user input from a second of devices 10 and/or by otherwise analyzing controller sensor input, multi-device input may be detected and used in manipulating virtual objects or taking other actions in system 8. Consider, as an example, the use of a tap gesture with device 10 to select a virtual object associated with a user's current point-of-gaze. Once the virtual object has been selected based on the direction of the user's point-of-gaze (or controller pointing direction input) and based on the tap gesture input or other user input, further user input gathered with one or more devices 10 may be used to rotate and/or otherwise manipulate the virtual object. For example, information on controller movement (e.g., rotational movement) may be gathered using an internal measurement unit or other sensor 18 in device(s) 10 and this rotational input may be used to rotate the selected object. In some scenarios, an object may be selected based on point-of-gaze (e.g., when a user's point-of-gaze is detected as being directed toward the object) and, following selection, object attributes (e.g., virtual object attributes such as virtual object appearance and/or real-world object attributes such as the operating settings of a real-world device) can be adjusted using strain gauge input, touch sensor input, controller orientation input (e.g., to rotate a virtual object, etc.).

If desired, gestures such as air gestures (three-dimensional gestures) with device 10 may involve additional input. For example, a user may control system 8 using hybrid gestures that involve movement of device(s) 10 through the air (e.g., an air gesture component) and that also involve contact between device 10 and one or more fingers of hand 40. As an example, an inertial measurement unit in device 10 and/or a camera in device 24 may detect user movement of device 10 through the air (e.g., to trace out a path) while a sensor 18 in device 10 such as a two-dimensional touch sensor, a force sensor, or other sensor 18 detects force input, touch input, or other input associated with contact to device 10.

The sensors in device 10 may, for example, measure how forcefully a user is moving device 10 against a surface (e.g., in a direction perpendicular to the surface) and/or how forcefully a user is moving device 10 along a surface (e.g., shear force in a direction parallel to the surface). The direction of movement of device 10 can also be measured by the force sensors and/or other sensors 18 in device 10.

Information gathered using sensors 18 such as force sensor input gathered with a force sensor, motion data gathered with a motion sensor (e.g., pointing input, rotations, etc.), location information indicating the location of controller 10, touch input gathered with a touch sensor, and other user input may be used to control external equipment such as device 24. For example, control circuitry 12 may send control signals to device 24 that include instructions to select a user interface element, instructions to scroll display content, instructions to select a different input function for controller 10 (e.g., to switch from using controller 10 as a drawing or writing implement to using controller 10 as a pointing device or game piece), instructions to draw a line or type a word on a display in device 24, instructions to adjust operational settings of device 24, instructions to manipulate display content on device 24, and/or instructions to take any other suitable action with device 24. These control signals may be sent in addition to or instead of providing feedback to sensor input from device 10 (e.g., haptic output, audio output, adjusting operational settings of device 10, etc.).

In the illustrative configuration of FIG. 2, device 10 includes touch sensor 42. Touch sensor 42 may be formed from an array of capacitive touch sensor electrodes such as electrodes 46 overlapping one or more surfaces of housing 54 such as curved surface C, flat surface F, and/or surfaces on tip portions T1 and T2. Touch sensor 42 may be configured to detect swipes, taps, multitouch input, squeeze input, and/or other touch input. In some arrangements, touch sensor 42 is formed from a one-dimensional or two dimensional array of capacitive electrodes 46. In some arrangements, touch sensor 42 may be a strain gauge that detects squeeze input to housing 54 (e.g., when a user squeezes or pinches device 10 between the user's fingers). Touch sensor 42 may be used to gather touch input such as input from direct contact and/or close proximity with a different finger of the user or other external object. In the example of FIG. 2, touch sensor 42 overlaps touch input area 44 on curved surface C of device 10. If desired, additional touch input may be gathered in adjacent areas such as flat surface F of housing 54. If desired, touch sensor 42 may include other types of touch sensing technologies such as optical touch sensors, acoustic-based touch sensors, etc. Touch sensor 42 may span the length L of device 10, may span only partially along length L of device 10, may cover some or all of curved surface C, may cover some or all of flat surface F, and/or may cover some or all of tip portions T1 and T2. If desired, touch sensor 42 may be illuminated, may overlap a display (e.g., to form a touch-sensitive display region on device 10), may overlap an indicator or textured surface, and/or may otherwise be visually or tangibly distinct from the surrounding non-touch-sensitive portions of housing 54 (if desired).

In addition to or instead of touch sensor 42, device 10 may include one or more other user input devices such as user input device 48. User input device 48 may be a mechanical input device such as a pressable button, a rotating knob, a rotating wheel, a rocker switch, a slider, or other mechanical input device, a force sensor such as a strain gauge or other force sensor, an optical sensor such as a proximity sensor, a touch sensor such as a capacitive, acoustic, or optical touch sensor, and/or any other suitable input device for receiving input from a user's hand 40. If desired, one of haptic output devices 20 such as an actuator may be used to provide haptic feedback in response to user input to device 48. For example, input device 48 may be a touch-sensitive button that does not physically move relative to housing 54, but the user may feel a localized button click sensation from haptic output that is provided from an actuator 20 overlapping device 48.

Haptic output devices 20 may be located in any suitable position within housing 54. In one illustrative arrangement, one or more haptic output devices 20 may be located at each end of shaft B such as at one or both of tip portions T1 and T2. Haptic output devices 20 may be configured to provide localized haptic feedback and/or global haptic feedback. Localized haptic feedback may be more prominent in a particular location of housing 54 relative to other portions of housing 54 (e.g., local haptic feedback may be more prominent at one or both of tip portions T1 and T2). Local haptic effects may be achieved by arranging the axis of a linear resonant actuator within housing 54 to be perpendicular to the longitudinal axis of device 10 (e.g., perpendicular to length L). Haptic output devices 20 may additionally or instead provide global haptic feedback that is prominent across most or all of the length of device 10. To achieve global haptic effects, the axis of a linear resonant actuator may be arranged in housing 54 to be parallel to the longitudinal axis of device 10 (e.g., parallel to length L).

In addition to or instead of touch sensor 42 and input device 48, device 10 may include one or more sensors at tip portions T1 and T2. For example, tip portion T1 and/or tip portion T2 may be force-sensitive. As shown in FIG. 2, device 10 may include sensor 52. Sensor 52 may be located at one or both of tip portions T1 and T2 and/or may be located elsewhere in device 10 such as at a location along shaft B of device 10. Shaft B, which may sometimes be referred to as a cylindrical housing, may form an elongated main body portion of housing 54 of device 10 that extends between tip T1 and tip T2. One or more of tip portions T1 and T2 may be removable and may sometimes be referred to as a cap, a writing tip, etc.

Sensors at tip portions T1 and T2 such as sensor 52 may include a device position sensor (e.g., an optical flow sensor having a light source that illuminates a portion of a surface that is contacted by device 10 and having an image sensor configured to determine a location of device 10 on the surface and/or to measure movement of the electronic device relative to the surface based on captured images of the illuminated portion, a mechanical position sensor such as an encoded wheel that tracks movements of device 10 on the surface, or other device position sensor), a force sensor (e.g., one or more strain gauges, piezoelectric force sensors, capacitive force sensors, and/or any other suitable force sensor), an optical proximity sensor such a light-emitting diode and light detector, a camera (e.g., a one-pixel camera or an in image sensor with a two-dimensional array of pixels), and/or other sensor. Arrangements in which device 10 includes multiple sensors 52 at tip T1 and/or tip T2 such as a device position sensor (e.g., an optical flow sensor, a visual inertial odometry sensor, an interferometer, etc.) for tracking movements of device 10 across a surface and a force sensor for detecting contact and force of contact with the surface are sometimes described herein as an example.

If desired, power can be conveyed wirelessly between device 10 and an external electronic device such as device 24 (e.g., a head-mounted device, a wireless charging mat, a storage case, a battery case, a wireless charging puck, or other electronic device). As an example, contacts (e.g., metal pads) may be capacitively coupled (without forming ohmic contact) to allow power to be transferred and/or power can be conveyed using a wireless power transmitter with a coil in device 24 to transmit wireless power signals to a wireless power receiver with a coil in device 10. Inductive power transfer techniques may be used (e.g., wireless power can be transmitted using one or more wireless power transmitting coils in device 24 and transmitted wireless power signals can be received in a power receiving circuit in device 10 using a power receiving coil such as coil 50). Received alternating-current wireless power signals from device 24 can be converted to direct-current power using a rectifier in device 10 for charging a battery in device 10 and/or for powering circuitry in device 10. In configurations in which the power receiving circuit of device 10 receives power via a wired connection (e.g., using terminals), the power receiving circuit in device 10 may provide the received power to a battery and/or other circuitry in device 10.

To help align wireless charging coil 50 in device 10 with a wireless charging coil in device 24 and/or to otherwise hold device 10 to a power source or other device (e.g., device 24 of FIG. 1), device 10 and device 24 may be provided with mating alignment features (e.g., mating protrusions and recesses and/or other interlocking alignment structures (e.g., key and keyhole structures that allow device 10 and/or device 24 to interlock when engaged by twisting or other locking motions), magnets (or ferromagnetic elements such as iron bars), and/or other alignment structures.

In configurations in which device 10 includes magnetic attachment structures (e.g., magnets, magnetic material that is attracted to magnets, or other magnetic attachment structures), device 10 may be held against the interior and/or exterior of device 24 using the magnetic attachment structures. For example, device 24 may be a battery case with a groove or other recess that receives device 10. Magnetic attachment structures in device 24 (e.g., near the groove) and in device 10 may corporate (magnetically attached) to help secure device 10 within the interior of the case (e.g., without allowing device 10 to rattle excessively inside the case). As another example, device 24 may be a head-mounted device (e.g., goggles and/or glasses) or a strap or other wearable device. In this type of arrangement, magnetic attachment structures may hold device 10 against an exterior surface of device 24 (e.g., against a portion of the housing of a pair of goggles or glasses such as along the frame of a pair of glasses, to the front, top, or side surface of a pair of goggles, etc.) or within a recess in the housing of device 24. Magnets and other alignment features may be located near coil 50 or may be located in other portions of housing 54.

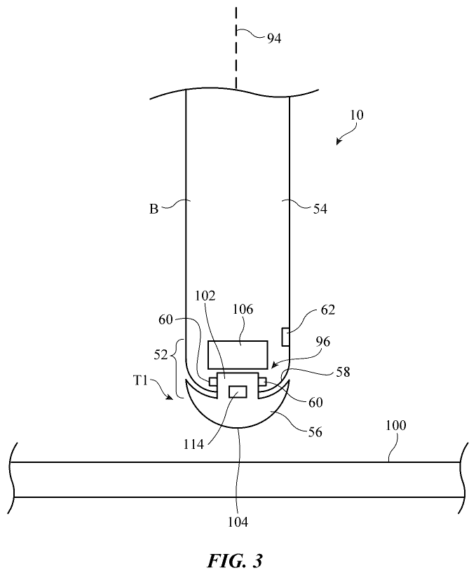

FIG. 3 is a side view of an illustrative portion of device 10 showing how one or more tip portions of device 10 may be removable. As shown in FIG. 3, device 10 may include a housing 54 having a shaft B that extends parallel to longitudinal axis 94 of device 10. Tip portion T1 may include a removable part such as removable tip member 56 that couples onto end surface 58 of tip portion T1. End surface 58 may have an opening such as opening 96. Opening 96 may be configured to receive a portion of tip member 56 when tip member 56 is inserted onto shaft B. For example, tip member 56 may have stem portion 102 that is received with opening 96 when tip member 56 is coupled to shaft B. Tip member 56 may have an outer surface 104 such as a semispherical outer surface, a planar outer surface, a cone-shaped outer surface, an asymmetric outer surface, and/or an outer surface have any other suitable shape.

Tip member 56 may be removably attached to main body portion B using a twist and lock mechanism (e.g., stem 102 may have threads that engage with corresponding threads in opening 96), a friction fit, magnetic attachment structures (e.g., magnets, magnetic material that is attracted to magnets, or other magnetic attachment structures), clasps, clips, interlocking engagement features, or any other suitable attachment mechanism.

In some arrangements, tip member 56 of tip portion T1 may be attached to shaft B using a retention mechanism such as retention member 60. Retention member 60 may be configured to hold tip member 56 in place when stem 102 is inserted into opening 96. In some arrangements, retention member 60 may be orthogonal to stem 102 and may interlock with a corresponding engagement feature on stem 102. Retention member 60 may engage with stem 102 when stem 102 is inserted into opening 96. A button or other release mechanism such as button 62 may be used to release retention member 60 so that tip member 56 can be removed. Alternatively, retention member 60 may hold tip member 56 in place using a friction fit having a magnetic release. For example, in the presence of a magnetic field (e.g., in the presence of a magnet or other element that produces a magnetic field), retention member 60 may disengage from tip member 56, thereby allowing tip member 56 to be removed from shaft B.

Controller 10 may be operable in a surface marking mode that allows controller 10 to “mark” on any external surface such as surface 100 (e.g., a tabletop surface, a desktop surface, the surface of a user's hand or arm, and/or any other suitable surface). Markings that are made with controller 10 on surface 100 may be displayed on a display such as a display in head-mounted device 24 or any other suitable display. The displayed markings may be virtually overlaid onto surface 100 at the precise location where the markings would be if controller 10 was a pen or pencil, or the markings may be displayed in other locations.

As discussed in connection with FIG. 2, controller 10 may include one or more sensors 52 at tip T1 for tracking movement of controller 10 across surface 100. Sensors 52 may include force sensor 106 and position tracking sensor 114. Force sensor 106 may be a resistive force sensor, a capacitive force sensor, a load cell, a strain gauge, and/or any other suitable force sensor. Force sensor 106 may be configured to detect when contact is made (and broken) between tip T1 (e.g., tip member 56) and surface 100 and how much force is applied during the contact. Device position sensor 114 may be an optical flow sensor (e.g., having a light source that creates a pattern of illumination on surface 100 and having an image sensor that captures images of the illuminated surface to track the location and/or relative movement of device 10 on surface 100), a standalone image sensor that does not include a light source, an interferometer, a mechanical position sensor such as an encoded wheel that tracks movements of device 10 on surface 100, and/or other device position sensor.

In the example of FIG. 3, force sensor 106 is located in a non-removable portion of tip T1, whereas device position sensor 114 is located in removable tip member 56. When removable tip member 56 is coupled to shaft B, forces may be translated to force sensor 106 through removable tip member 56. If desired, both device position sensor 114 and force sensor 106 may be located in the non-removable portion of tip T1 (e.g., removable tip member 56 may be free of sensors), or both device position sensor 114 and force sensor 106 may be located in removable tip member 56. Arrangements in which device position sensor 114 is located in non-removable portion of tip T1 while force sensor 106 is located in removable tip member 56 may also be used. The example of FIG. 3 is merely illustrative.

If desired, the operating mode of device 10 may change depending on whether force sensor 106 detects contact between tip T1 and surface 100. For example, when force sensor 106 detects contact between tip T1 and surface 100, controller 10 may be operated in a surface marking mode. In surface marking mode, device position sensor 114 may be activated to track the motion of tip T1 across surface 100 and an external display may be configured to display content based on the markings made on surface 100 with controller 10. If desired, position sensor 114 may be operated in a high precision mode such as a high frame rate mode when force sensor 106 detects contact with surface 100 and controller 10 enters surface marking mode. This allows position sensor 114 to track even very small movements of tip T1 across surface 100 so that the displayed markings accurately reflect the movement of tip T1 across surface 100. Although controller 10 may not leave any physical marks on surface 100, the surface markings may be displayed virtually and overlaid onto surface 100 and/or may be displayed elsewhere by device 24.

When force sensor 106 detects that the contact between controller 10 and surface 100 has ceased (e.g., for some duration of time), controller 10 may be operated in a different mode (e.g., air input mode, gesture mode, gaming mode, other non-surface-marking modes, etc.) and position sensor 114 may be deactivated or may enter another mode of operation. For example, controller 10 and position sensor 114 may be operable in an air input mode in which position sensor 114 is used for keypoint detection, image classification, object identification, and/or other computer vision purposes that do not require the high precision position tracking that is used for surface marking mode. If desired, position sensor 114 may have a reduced frame rate to save power in air input mode (sometimes referred to as keypoint detection mode).

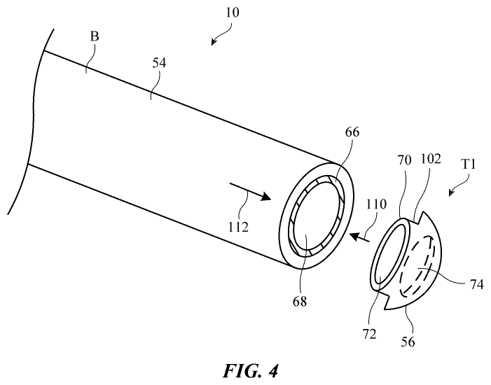

FIG. 4 is a perspective view of controller 10 showing an illustrative example in which tip T1 has a trap door for receiving removable tip member 56. As shown in FIG. 4, tip portion T1 may include a spring-loaded member such as spring-loaded member 66. Spring-loaded member 66 may be biased in direction 112 with a compression spring and may surround a magnet such as magnet 68. Removable tip member 56 may have a corresponding magnet 74 that is magnetically attracted to magnet 68. Stem 102 of tip member 56 may have walls 70 that surround a central opening such as opening 72. When a user pushes tip member 56 against the end of shaft B in direction 110, walls 70 may align with spring-loaded member 66 and may apply a force against spring-loaded member 66, thereby causing spring-loaded member 66 to retract into housing 54 of shaft B in direction 110. The retraction of spring-loaded member 66 into housing 54 creates an opening (e.g., a recess, groove, trench, etc.) around magnet 68 for receiving walls 70. As walls 70 move into the opening, the magnetic force between magnet 74 and magnet 68 may overcome the spring force against spring-loaded member 66. Tip member 56 may be held in place on shaft B by the magnetic attraction force between magnets 74 and 68. The user may remove tip member 56 by pulling tip member 56 away from shaft B in direction 112.

The circular shape of spring-loaded member 66 is merely illustrative. If desired, spring-loaded member 66 may have a ring shape, a rectangular shape, an oval shape, or any other suitable shape depending on the shape of walls 70 of removable tip member 56 (e.g., if removable tip member 56 has rectangular walls 70, spring-loaded member 66 may have a matching rectangular shape so that a rectangular opening is formed around magnet 68 of tip portion T1 when spring-loaded member 66 retracts into housing 54.

If desired, member 66 may have a magnetic release instead of being spring biased. For example, member 66 may include magnetic material and may be configured to retract into housing 54 in direction 110 in response to an applied magnetic field (e.g., a magnetic field coming from magnet 74 in tip member 56).

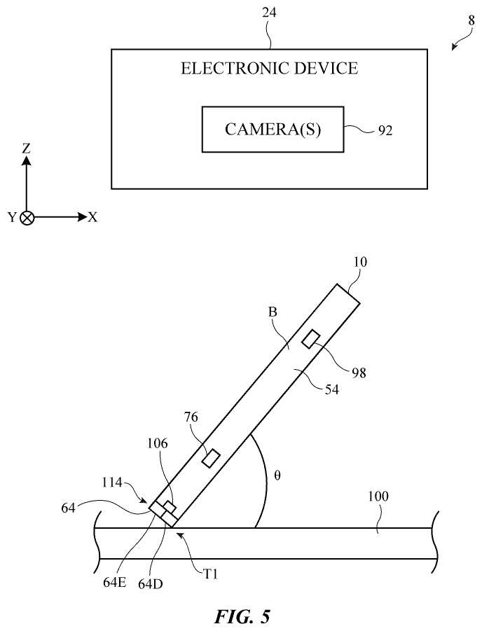

FIG. 5 is a diagram of system 8 showing an illustrative example in which position sensor 114 is formed from an optical flow sensor such as optical flow sensor 64. Optical flow sensor 64 may be configured to track the location of controller 10 relative to surface 100. Optical sensor 64 may include one or more light emitters such as light source 64E and one or more image sensors such as image sensor 64D. Image sensor 64D may include a two-dimensional array of image sensing pixels. Light source 64E may include an array of infrared light-emitting diodes that produces a pattern of illumination on surface 100 (e.g., a speckle pattern or any other suitable pattern of illumination). Image sensor 64D may capture images of the illuminated portion of surface 100 to track how the pattern changes and what direction the pattern is moving. Force sensor 106 may be mounted behind optical sensor 64.

Optical sensor 64 may be used to determine coordinates of tip T1 on surface 100 in the X-Y plane of FIG. 5. When tip T1 is flat and parallel to surface 100, the coordinates measured by optical sensor 64 may accurately reflect the location of tip portion T1 on surface 100. If controller 10 is angled and tip T1 is not parallel to surface 100 (e.g., when the longitudinal axis of shaft B is not orthogonal to surface 100), then device 10 may use one or more additional sensors to determine the angle θ at which controller 10 is oriented relative to surface 100. For example, motion sensor 98 may include an accelerometer, gyroscope, and/or compass and may produce motion sensor data that can be used to determine angle θ. Alternatively or additionally, cameras in device 10 such as camera 76 and/or cameras in an external electronic device such as camera 92 in device 24 may be used to measure angle θ. If desired, liftoff information may also be captured by camera 76 and/or camera 92. This may include determining the distance between tip portion T1 and surface 100 when tip portion T1 lifts away from surface 100.

Control circuitry 12 may use sensor fusion techniques to analyze motion sensor data from motion sensor 98, image sensor data from camera 76 and/or camera 92, and two-dimensional position data from optical flow sensor 64 to determine the position of tip portion T1 on surface 100. This may include, for example, determining a first set of coordinates (e.g., x and y coordinates in the X-Y plane of surface 100 of FIG. 5) based on optical flow sensor data gathered with optical flow sensor 64, gathering tilt information (e.g., angle θ) and/or liftoff information from motion sensor 98, camera 76, and/or camera 92, and transposing the first set of coordinates to a second set of coordinates (e.g., modified x and y coordinates) based on the tilt and/or liftoff information. The second set of coordinates may reflect the location of tip T1 on surface 100 more accurately than the first set of coordinates because it accounts for the non-parallel orientation between optical flow sensor 64 and surface 100.

If desired, optical flow sensor 64 may be operable in multiple modes such as a surface marking mode (sometimes referred to as high precision mode) and an air input mode (sometimes referred to as keypoint detection mode). In surface marking mode, optical flow sensor 64 may operate with higher precision in order to precisely track the location of tip T1 on surface 100. When performing precise location tracking on surface 100, optical flow sensor 64 may operate with a higher frame rate to accurately capture the (virtual) markings made on surface 100 with controller 10. In air input mode, controller 10 is not being used for surface marking and optical flow sensor 64 may be repurposed for computer vision purposes such as object detection, image classification, and keypoint detection. Optical flow sensor 64 may not need as a high of a frame rate to perform computer vision processing. For example, computer vision algorithms for keypoint detection may use a frame rate of 10-30 frames per second or other suitable frame rate, whereas optical flow sensing for surface marking purposes may use a frame rate of more than 100 frames per second or other suitable frame rate.

Force sensor 106 may be used to determine when to adjust the operational mode of optical flow sensor 64. For example, when force sensor 106 detects contact between tip T1 and surface 100, optical flow sensor 64 may be switched from keypoint detection mode to surface marking mode so that surface markings with controller 10 on surface 100 can be tracked and displayed on an external display. When force sensor 106 indicates that contact between tip T1 and surface 100 has ceased (e.g., for some predetermined period of time), optical flow sensor 64 may be deactivated or may enter another mode of operation (e.g., optical flow sensor 64 may return to keypoint detection mode with a reduced frame rate to save power). This is merely illustrative, however. If desired, optical flow sensor 64 may switch modes based on user activity (e.g., based on information from device 24 and/or controller 10 indicating that the user is about to start a surface marking session and/or has just finished a surface marking session). In other arrangements, flow sensor 64 may operate at a reduced frame rate suitable for keypoint detection while pulsing a high frame rate for precision location tracking at select times. If desired, keypoint detection can be performed using image data captured during surface marking mode (e.g., using every 10^{th} frame of the high frame rate image data for keypoint detection).

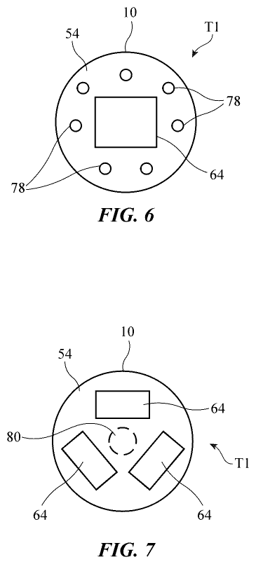

In addition to or instead of using motion sensor 98, camera 76, and/or camera 92 to determine angle θ, device 10 may use one or more light-emitting elements adjacent to optical flow sensor 64 to help determine angle θ. As shown in FIG. 6, for example, controller 10 may include light-emitting elements 78 distributed around the periphery of optical flow sensor 64. Light-emitting elements 78 may be configured to emit light in sequence and/or in a time-synchronized pattern that allows angle θ to be determined (e.g., by emitting a pattern of illumination on surface 100 in a given time sequence, using image sensor 74D to measure the reflected light, and triangulating angle θ based on the measured light).

FIG. 7 is a side view of controller 10 showing how tip T1 of controller 10 may include multiple optical flow sensors 64. As shown in FIG. 7, tip portion T1 may include three optical flow sensors 64. This is merely illustrative. If desired, there may be one, two, three, four, five, or more than five optical flow sensors 64 in tip T1 of controller 10. To protect optical flow sensors 64 from damage, optical flow sensors 64 may be offset from areas of tip T1 that make contact with external surfaces such as contact area 80. Contact area 80 may be in the center of tip T1 or may be offset from the center of tip T1 (e.g., contact area 80 may be along an edge or periphery of tip T1). To offset optical flow sensors 64 from contact area 80, optical flow sensors may be positioned in non-overlapping regions of tip T1 that do not overlap with contact area 80. In other arrangements, optical flow sensors 64 may be offset from contact area 80 by recessing optical flow sensors 64 within housing 54 of controller 10. This allows optical flow sensors 64 to overlap contact area 80 but to be recessed relative to contact area 80 so that surface marking with controller 10 does not damage optical flow sensor 64.

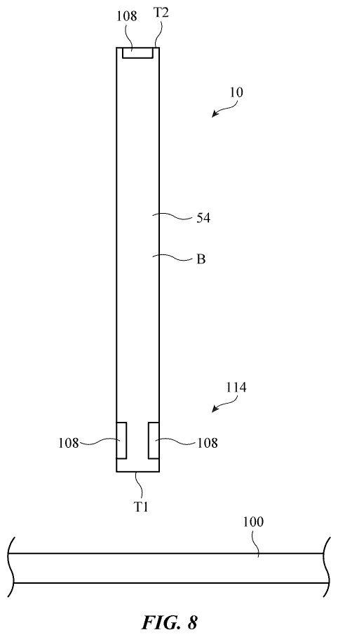

In the example of FIG. 8, position sensor 114 is formed using one or more cameras such as cameras 108 distributed at different locations along controller 10. Cameras 108 may be visual odometry sensors, visual inertial odometry sensors, infrared image sensors, visible image sensors, three-dimensional image sensors, depth sensors, and/or other cameras for capturing two-dimensional and/or three-dimensional images and/or video of the surrounding environment of controller 10.

Cameras 108 may be located in tip T1 where contact with surface 100 occurs, or cameras 108 may be located away from tip T1 where contact with surface 100 occurs. As shown in FIG. 8, for example, cameras 108 may be located on opposing sides of shaft B, may be located at tip T2, and/or may be located elsewhere in controller 10. Control circuitry 12 may analyze captured image data from cameras 108 to track the location of controller 10 relative to surface 100. Additionally, control circuitry 12 may analyze captured image data from cameras 108 to detect and identify other objects in the environment using object detection, image classification, and keypoint detection, and/or other computer vision techniques. If desired, cameras 108 may be operated in different modes such as a device position tracking mode and a keypoint detection mode. Device position tracking mode may use a higher frame rate for cameras 108 to obtain precise tracking information when controller 10 is marking on a surface such as surface 100. Keypoint detection mode may use a lower frame rate for cameras 108 as cameras 108 are used to detect and identify objects in the environment surrounding controller 10 (e.g., when controller 10 is being used in air input mode, gesture mode, or any other non-surface-marking mode).

If desired, cameras 108 may be adjusted between modes (e.g., the frame rate or other operational settings of cameras 108 may be adjusted) based on information from force sensor 106 (FIG. 3). For example, when force sensor 106 indicates contact between tip T1 and surface 100, cameras 108 may be switched from keypoint detection mode to device position tracking mode so that surface markings with controller 10 on surface 100 can be tracked and displayed on an external display. When force sensor 106 indicates that contact between tip T1 and surface 100 has ceased (e.g., for some predetermined period of time), cameras 108 may be deactivated or may enter another mode of operation (e.g., camera 108 may return to keypoint detection mode with a reduced frame rate).

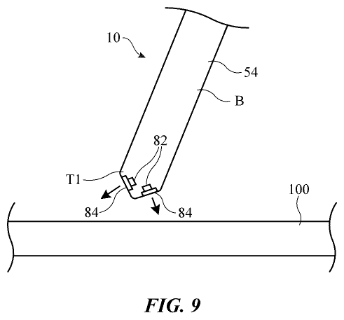

If desired, interferometry (e.g., optical interferometry) may be used in measuring the position of device 10 on surface 100. As shown in FIG. 9, for example, device position sensor 114 may include one or more interferometers such as interferometers 82. Interferometers 82 may be distributed at one or more locations of tip T1. Each interferometer 82 may be a self-mixing interferometer having a coherent or partially coherent source of electromagnetic radiation. The source of radiation may, for example, be a coherent light source such as an infrared vertical cavity surface-emitting laser, a quantum cascade laser, or other laser. Interferometers 82 may also have a beam splitter and a light detector such as a photodiode and/or other electromagnetic-radiation-sensitive element.

During operation, the laser in interferometer 82 may emit light through the beam splitter. The beam splitter may direct a first portion of the light towards a fixed surface in controller 10 and may direct a second portion of the light towards surface 100. The second portion of the light may exit controller 10 through an infrared-transparent window such as window 84 towards surface 100. The photodiode or other light-sensitive element in interferometer 82 may detect the first and second portions of light that are reflected back to interferometer 82. As a result of interference between the first and second portions of light, a relative phase of the first and second portions of light (and therefore changes in distance between controller 10 and surface 100) can be measured by sensor 82. Device 10 may use sensors 82 to monitor the distance to surface 100 while also capturing velocity information of controller 10 relative to surface 100.

As described above, one aspect of the present technology is the gathering and use of information such as sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A handheld controller, comprising:
a housing having an elongated shaft extending between first and second tip portions;
a removable tip member configured to be coupled to the first tip portion, wherein the removable tip member comprises a position sensor that tracks a position of the first tip portion relative to a surface; and
a force sensor in the first tip portion configured to gather force input through the removable tip member.

2. The handheld controller defined in claim 1 wherein the force sensor comprises a strain gauge.

3. The handheld controller defined in claim 1 wherein the position sensor comprises an optical flow sensor.

4. The handheld controller defined in claim 3 wherein the optical flow sensor comprises an infrared light source that emits a pattern of illumination onto the surface and an image sensor that captures an image of the pattern of illumination on the surface.

5. The handheld controller defined in claim 3 wherein the optical flow sensor is operable in a first mode in which a first frame rate is used for tracking the position of the first tip portion relative to the surface and a second mode in which a second frame rate is used for keypoint detection, wherein the second frame rate is lower than the first frame rate.

6. The handheld controller defined in claim 5 wherein the optical flow sensor is adjusted between the first mode and the second mode based on the force input gathered with the force sensor.

7. The handheld controller defined in claim 6 wherein the optical flow sensor switches from the second mode to the first mode when the force input indicates contact between the removable tip member and the surface.

8. The handheld controller defined in claim 1 wherein the removable tip member is configured to be coupled to the first tip portion using a friction fit with a magnetic release.

9. The handheld controller defined in claim 1 wherein the first tip portion has a spring-loaded member that retracts into the housing to form an opening that receives the removable tip member.

10. The handheld controller defined in claim 1 wherein the position sensor comprises an interferometer.

11. The handheld controller defined in claim 1 further comprising:
a motion sensor that gathers motion sensor data;
a camera that captures image data; and
control circuitry configured to determine a tilt of the elongated shaft relative to the surface based on at least one of the motion sensor data and the image data, wherein the position of the first tip portion relative to the surface is determined based on the tilt.

12. An electronic device, comprising:
a housing having an elongated shaft extending between first and second tip portions;
an optical sensor at the first tip portion and configured to capture image data, wherein the optical sensor is operable in a surface marking mode and an air input mode; and
a force sensor configured to detect contact between the first tip portion and a surface, wherein the optical sensor is operated in the surface marking mode in response to detecting contact between the first tip portion and the surface.

13. The electronic device defined in claim 12 wherein the optical sensor comprises a camera and wherein the camera has a higher frame rate in the surface marking mode than in the air input mode.

14. The electronic device defined in claim 12 further comprising control circuitry configured to analyze the image data using key point detection techniques in the air input mode.

15. The electronic device defined in claim 12 further comprising a motion sensor and a camera, wherein the control circuitry is configured to determine an angle of the elongated shaft relative to the surface based on information from at least one of the motion sensor and the camera.

16. The electronic device defined in claim 12 wherein the optical sensor is located in a removable part of the first tip portion and the force sensor is located in a non-removable part of the first tip portion.

17. A handheld controller, comprising:
a housing having an elongated shaft extending between first and second tip portions;
a removable tip member coupled to the first tip portion, wherein the removable tip member comprises an optical flow sensor for tracking surface markings made by the handheld controller on a surface; and
a spring-loaded member configured to retract into the housing to form an opening that receives a portion of the removable tip member.

18. The handheld controller defined in claim 17 wherein the first tip portion comprises a first magnet and the removable tip member comprises a second magnet that is attracted to the first magnet.

19. The handheld controller defined in claim 17 further comprising infrared light sources at the first tip portion that produce a sequence of illumination on the surface, wherein the optical flow sensor captures images of the illumination to determine an angle of the elongated shaft relative to the surface.

20. The handheld controller defined in claim 17 further comprising a force sensor at the first tip portion and configured to detect contact between the removable tip member and the surface.
